(19) United States
(12) Patent Application Publication
(10) Pub. No.: US 2013/0173355 A1
(43) Pub. Date: Jul. 4, 2013

(54) SYSTEM AND METHOD FOR DISSEMINATION AND ASSESSMENT OF PERFORMANCE METRICS AND RELATED BEST PRACTICES INFORMATION

(71) Applicant: Camilo Barcenas, San Francisco, CA (US)

(72) Inventor: Camilo Barcenas, San Francisco, CA (US)

(73) Assignee: Camilo Barcenas, San Francisco, CA (US)

(21) Appl. No.: 13/710,408

(22) Filed: Dec. 10, 2012

Related U.S. Application Data
(60) Provisional application No. 61/569,030, filed on Dec. 9, 2011.

(51) Int. Cl. G06Q 10/06

(52) U.S. Cl. CPC G06Q 10/06393
USPC 705/7.39

(57) ABSTRACT

A software and/or hardware facility for assessing performance-related metrics (performance metrics) of a workplace or other entity and disseminating related best practices information for how to improve specific metrics is provided. The facility provides social networking and media services that enable users to find and share materials related to various performance metrics that can be used to improve quality of service and care. The facility provides an international collaborative performance management platform that aligns users on various metrics, objectives, and initiatives and identifies and highlights best practices information for those users to consume for purposes of increasing performance with respect to the various metrics, objectives, and initiatives. Thus, users may use the facility to track and share performance-related metric data, discuss this data with interested parties, and collaborate around this data and the related metrics to improve quality of service and care.

### CROSS-REFERENCE TO RELATED APPLICATIONS

This application claims the benefit of U.S. Patent Application No. 61/569,030, filed Dec. 9, 2011, entitled SYSTEM AND METHOD FOR ASSESSING PERFORMANCE METRICS AND DISSEMINATING RELATED BEST PRACTICES INFORMATION, which is herein incorporated by reference in its entirety. To the extent the foregoing application or any other material incorporated herein by reference conflict with the present disclosure, the present disclosure controls.

### BACKGROUND

Quality of service and care are important performance metrics in the assessment and success of any service provider. Accordingly, service providers are interested in monitoring and tracking their own measures of quality of service and care and sharing that information with, for example, employees, those to whom they provide goods or services, and so on. For example, a restaurateur may encourage her patrons to complete a survey after dining at her restaurant. The restaurateur may use this information to assess the performance of her employees (e.g., hosts, wait staff, chefs) to determine where her restaurant excels and where her restaurant could use improvement. The restaurateur may then post this information within her restaurant to share the results with her employees. This information, however, may be overwhelming to some of employees, irrelevant to some of the employees, and/or incomplete/outdated. Additionally, the restaurateur may have some difficulty scheduling meetings to present this information to her employees due to, for example, scheduling conflicts, varied work schedules, and so on. Furthermore, once the restaurateur has identified those areas in which her restaurant may need improvement, she may wish to identify and distribute materials that will assist in such improvement. For example, if the restaurateur could find best practices guides for improving certain restaurant performance metrics and distribute those guides to her employees, her restaurant performance metrics may improve. Current guides, however, may be difficult to find and/or acquire.

### BRIEF DESCRIPTION OF THE DRAWINGS

FIG. 1 is a block diagram illustrating an environment in which the facility may operate.

FIG. 2 is a block diagram illustrating some of the components that may be incorporated in at least some of the computer systems and other devices on which the facility operates and interacts with.

FIG. 3 is a flow diagram illustrating the processing of a create account component.

FIG. 4 is a flow diagram illustrating the processing of a generate entity profile page.

FIGS. 5a and 5b are display pages illustrating an entity profile page.

FIG. 6 is a display page illustrating an update splash page.

FIGS. 7A and 7B represent a display page illustrating an announcements page.

FIG. 8 is a display page illustrating a metrics portal page.

FIGS. 9A and 9B represent a display page illustrating a best practices portal page.

FIGS. 10A and 10B represent a display page illustrating a composite metric page.

FIG. 10C is a display page illustrating a metric page.

FIG. 11 is a display page illustrating a groups page.

FIG. 12A is a display page illustrating a metric group comments page.

FIG. 12B represents the dynamic movement of a discussion panel stack in response to user interactions with the panel stack.

FIG. 13 is a display page representing a portion of a hospital profile page.

FIG. 14 is a display page illustrating a metric performance ranking page.

FIG. 15 is a display page illustrating a historical information page for a metric.

FIG. 16 is a block diagram illustrating the processing of an overall ranking component.

### DETAILED DESCRIPTION

An example software and/or hardware facility for assessing performance-related metrics (performance metrics) of a workplace or other entity (e.g., hospital, clinic, doctor's office, mechanic, accounting firm, law firm, restaurant) and disseminating related best practices information for improving specific metrics is provided. The facility provides social networking and media services that enable users to find and share materials related to various performance metrics that can be used to improve quality of service and care. In some examples, the facility collects performance-related data from various public and/or private sources, such as data.medicare.org, healthgrades.com, surveys, and so on, and assesses the collected data to establish scores or relative performance rankings for a number of different metrics used to assess how entities provide services to clients, customers, etc. For example, the collected data may include, for each of a number of entities, data related to client or customer satisfaction, the success rate of provided services (e.g., surgeries, medical treatments, automotive repairs), compliance with regulatory or legal guidelines, the level of care provided by the entity relative to accepted standards of care or other practice parameters, and so on. Using this information, the facility may rank all of the entities from top to bottom to enable users to understand, for example, how their associated entity (e.g., workplace) compares to others. In some cases, a data set may include a number of composite metrics comprising a number of other metrics. In these cases, the facility may enable users to retrieve performance information for both the composite metric (e.g., average scores or rankings among the component metrics) and the metrics that comprise the composite metric. In some cases, an entity may generate its own composite metrics by grouping together a number of other composite or non-composite metrics. The facility provides an international collaborative performance management platform that aligns users on various metrics, objectives, and initiatives and identifies and highlights best practices information for those users to consume for purposes of increasing performance with respect to the various metrics, objectives, and initiatives. Thus, users may use the facility to track and share performance-related metric data, discuss this data with interested parties, and collaborate around this data and the related metrics to improve quality of service and care.

In some examples, entities can be defined according to various levels of granularity, each corresponding to a different sub-entity (i.e., an entity that is a subset of a larger entity). For example, a hospital entity may be comprised of various location sub-entities, such as wing sub-entities, building sub-entities, floor sub-entities, shift sub-entities, and so on. The facility provides an interface comprising a number of actionable tools that users can access and interact with to monitor the performance of their associated entity, compare their associated entity's performance to other entities, find and share best practices materials with other users, identify continuing education courses, and participate in related conversations with other users in an effort to both improve the quality of services rendered by the user's associated entity and the industry as a whole.

In some examples, the facility associates users with an entity at the time of registration based on, for example, their email address and/or additional details provided by the user. For example, the facility may associate users with email addresses from a particular domain with a related entity, such as associating kp.org with Kaiser Permanente or vmmc.org with Virginia Mason Medical Center. In some cases, the facility may request that the user specify a particular location if the entity has several offices or locations. Furthermore, the facility may allow users to specify additional details about their association with the entity, such as their job title, specialty, responsibilities, floor number, hours worked, supervisor, and so on. Job title information may be specified according to various levels of granularity (e.g., doctor, surgeon, ophthalmic surgeon, head of ophthalmology, nurse, chief nursing officer, staff nurse, charge nurse, hemodialysis nurse). Using this information, the facility can identify the user's coworkers (e.g., other users associated with the same entity, users associated with the same entity and having the same job title, other users who work at the same location, other users who work on the same floor) or professional peers (e.g., users associated with a different entity and having the same job title or responsibilities). Moreover, the facility may collect additional details about the user, such as level of education, schools attended, credentials, previous positions or job titles, previous places of employment, and so on.

In some examples, the facility provides a web interface through which users can view information related to the performance of their associated entity and/or location based on the collected performance data. The facility provides various display pages (e.g., web pages) through which users can track data related to the performance of their associated entity (or sub-entity) for each of a plurality of metrics. Furthermore, the facility enables users to compare the performance of various entities (or sub-entities) and, in some cases, compare the performance to specified targets for each metric established by, for example, an administrator at each entity (or sub-entity) (e.g., the Head of Operations of a hospital, CEO, CFO, CIO, CMIO, CNO). In this manner, users can better understand how their associated entity or sub-entity is performing relative to other entities and/or any established performance targets for each metric. Moreover, the facility encourages access to the best practices materials (e.g., articles published in industry journals, magazines, or other publications, user-generated content, books, online references) for various metrics. Based on user interactions with the best practices materials, the facility ranks the materials to provide interested users with the more desired or used best practices materials. For example, best practices materials may be ranked based on how often they are liked, shared, or read and the attributes of the users who liked, shared, or read the materials. Accordingly, the facility enables users to identify areas of interest and quickly find best practices materials that the user can employ to implement new procedures or practices to improve performance ranking of the user's associated entity with respect to one or more metrics.

In some examples, the facility enables users to “follow” or select favorites from among the various metrics or best practices materials. Links to these “followed” items are displayed to the user as the user browses the web interface provided by the facility so that the user can quickly access their favorite items. Furthermore, the facility enables user to add other users as friends and create groups of users where they can discuss matters relevant to the group.

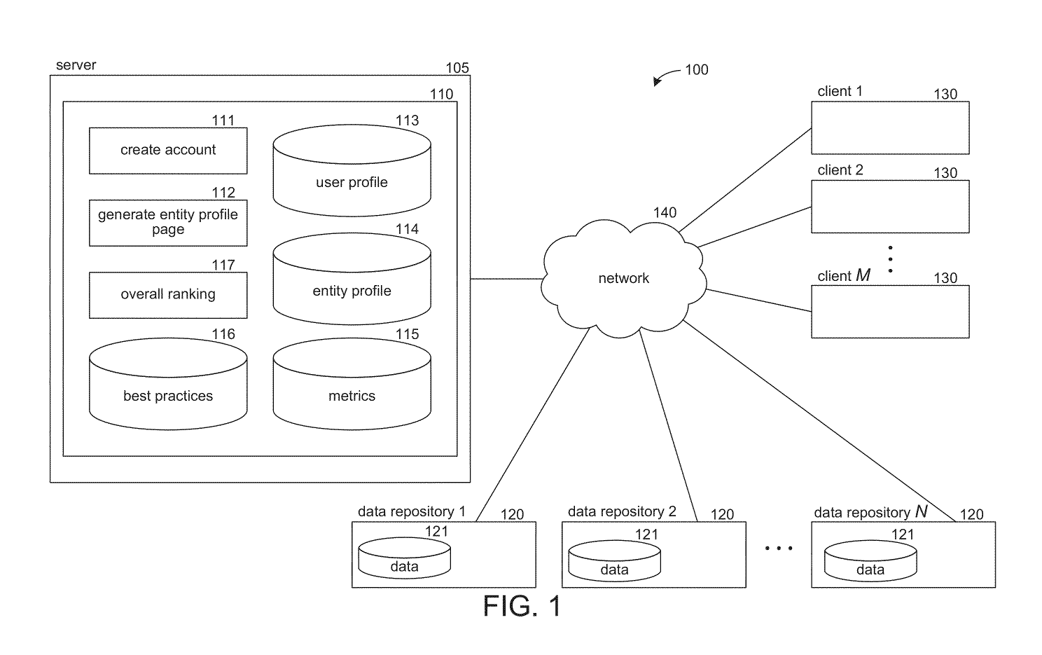

FIG. 1 is a block diagram illustrating an environment 100 in which the facility may operate in some examples. In this example, the environment 100 is comprised of server computing system 105, data repository computer systems 120, client computer systems 130, and network 140. Server computing system 105 hosts facility 110, which comprises a create account component 111, a generate entity profile page 112, an overall ranking component 117, user profile store 113, location profile store 114, metrics data store 115, and best practices store 116. The facility 110 invokes the create account component 111, which is configured to collect and retrieve user-related information, during a user registration process. The facility 110 invokes the generate entity profile page component 112, for example, in response to receiving a request to view the profile page of a particular entity. The overall ranking component 117 is configured to generate an overall ranking for an entity. User profile store 113 stores user account information, such as a user's email address, associated entity (or sub-entities), favorites or followed items, friends list, job title, job responsibilities, level of education, schools attended, credentials, previous positions or job titles, previous places of employment, and so on. Entity profile store 114 stores information related to each entity (or sub-entity), such as administrative information, lists of associated users, lists of associated groups, performance targets associated with each entity, logos and other graphics, and so on. Metrics data store 115 stores performance-related data for each of various entities collected from various sources, such as user surveys, public and/or private data repository computer systems 120 (e.g., systems provided by data.medicare.org, healthgrades.com) comprising data stores 121, and so on. The performance-related data may include, for example, current and historic rankings or performance scores, links to associated best practices materials, related user-generated content (e.g., comments) related to each metric, and so on. Best practices store 116 stores information pertaining to best practices materials, such as publications, links to publications, ratings, related user-generated content (e.g., comments), title, author, provider, and so on. Users may interact with the facility 110 via client computer systems 130 over network 140 using a user interface provided by, for example, a web browser or other application. In this example, data repository computer systems 120 and client computer systems 130 are connected via network 140 to the server computing system 105 hosting the facility 110.

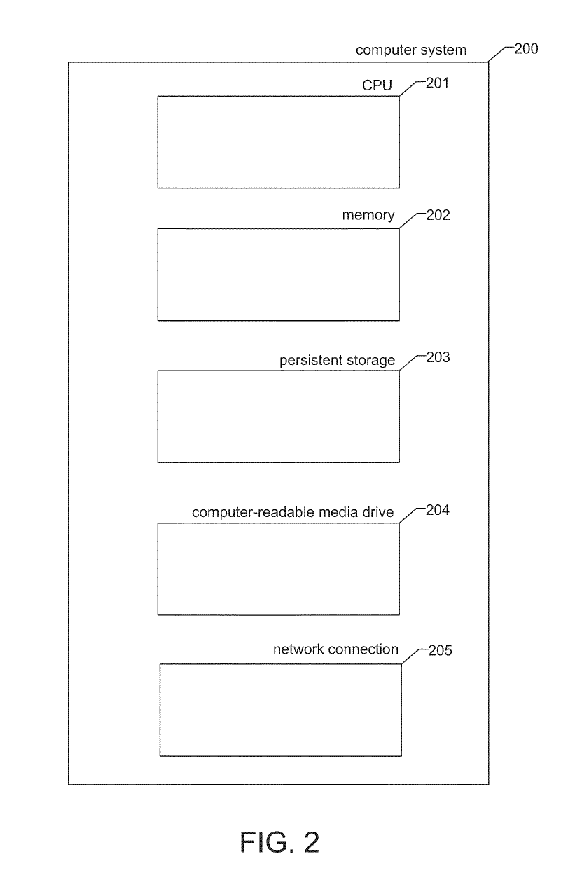

FIG. 2 is a block diagram illustrating some of the components that may be incorporated in at least some of the computer systems and other devices on which the facility 110 operates and interacts with in some examples. In various examples, these computer systems and other devices 200 can include server computer systems, desktop computer systems, laptop computer systems, netbooks, tablets, mobile phones, personal digital assistants, televisions, cameras, automobile computers, electronic media players, and/or the like. In various examples, the computer systems and devices include one or more of each of the following: a central processing unit (“CPU”) 201 configured to execute computer programs; a computer memory 202 configured to store programs and data while they are being used, including a multithreaded program being tested, a debugger, the facility, an operating system including a kernel, and device drivers; a persistent storage device 203, such as a hard drive or flash drive configured to persistently store programs and data; a computer-readable storage media drive 204, such as a floppy, flash, CD-ROM, or DVD drive, configured to read programs and data stored on a computer-readable storage medium, such as a floppy disk, flash memory device, a CD-ROM, a DVD; and a network connection 205 configured to connect the computer system to other computer systems to send and/or receive data, such as via the Internet, a local area network, a wide area network, a point-to-point dial-up connection, a cell phone network, or another network and its networking hardware in various examples including routers, switches, and various types of transmitters, receivers, or computer-readable transmission media. While computer systems configured as described above may be used to support the operation of the facility, those skilled in the art will readily appreciate that the facility may be implemented using devices of various types and configurations, and having various components. Elements of the facility may be described in the general context of computer-executable instructions, such as program modules, executed by one or more computers or other devices. Generally, program modules include routines, programs, objects, components, data structures, and/or the like configured to perform particular tasks or implement particular abstract data types and may be encrypted. Moreover, the functionality of the program modules may be combined or distributed as desired in various examples. Moreover, display pages may be implemented in any of various ways, such as in C++ or as web pages in XML (Extensible Markup Language), HTML (HyperText Markup Language), JavaScript, AJAX (Asynchronous JavaScript and XML) techniques or any other scripts or methods of creating displayable data, such as the Wireless Access Protocol (“WAP”).

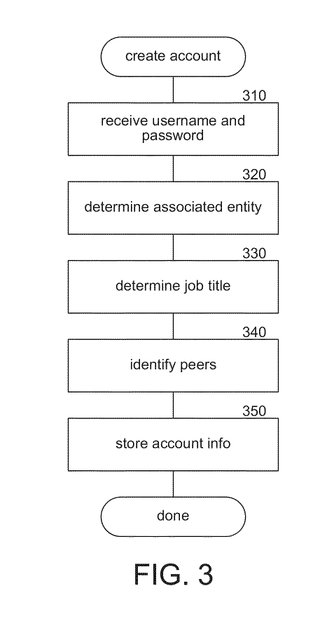

FIG. 3 is a flow diagram illustrating the processing of a create account component in some examples. The facility invokes the create account component, which is configured to collect and retrieve user-related information, during a user registration process. In block 310, the component receives a user name and password from the user. In some examples, the user name may correspond to an email address associated with the user and a particular entity (e.g., a work email address). In block 320, the component determines the entity associated with the user. For example, the component may analyze the domain name of a provided email address to associate the user with a particular entity, such as a hospital, accounting firm, and so on. If the component cannot determine an entity, the component may prompt the user to provide additional details, such as the name of a particular entity. In some examples, the component may prevent users from creating an account if they are not associated with an entity for which the facility has collected data or an entity that has registered with the facility. In block 330, the component determines the user's job title by, for example, accessing information that was previously collected for the associated entity or user, crawling the entity's website, or prompting the user to provide job title information. In block 340, the component identifies the user's professional peers based on other registered users who share the same or a similar job title or job responsibilities. In block 350, the component stores the gathered user account information in the user profile store and then completes.

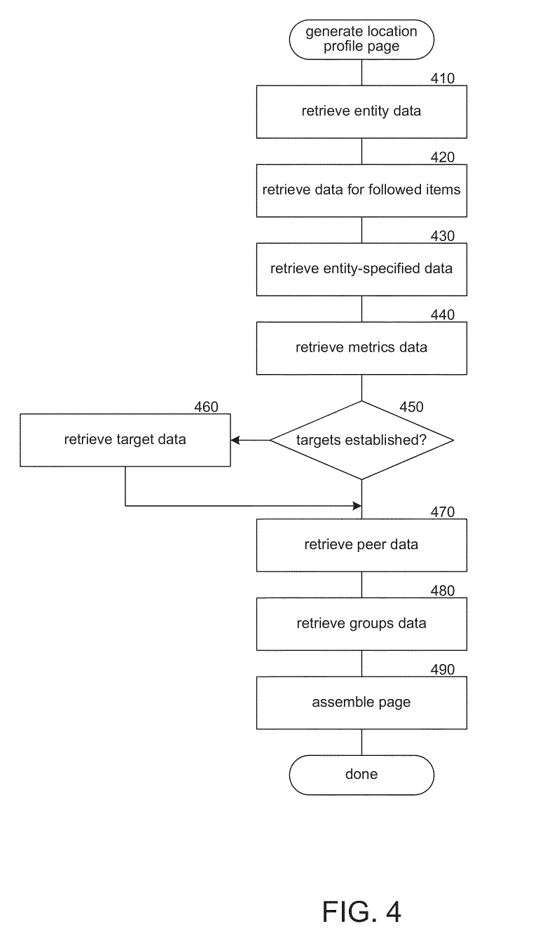

FIG. 4 is a flow diagram illustrating the processing of a generate entity profile page in some examples. The facility 110 invokes the generate entity profile page component 112, for example, in response to receiving a request to view the profile page of a particular entity. In block 410, the component retrieves data for the entity from the entity profile store, such as name, administrative information, relevant graphics, and so on. In block 420, the component identifies followed items and retrieves related data, such as an indication of any new or updated metrics data, best practices materials, group data, user comments, and so on. In block 430, the component receives any entity-specified data. The entity-specified data corresponds to any data that has been designated by the entity (e.g., an administrator) to be displayed on the entity profile page, such as an announcement from the CEO or Head of Operations, an indication of any metrics that are of particular importance to the entity (e.g., metrics for which the entity is receiving the highest and lowest rankings), preferred best practices materials, and so on. In this manner, the entity can ensure that materials important to the entity are displayed or made easily accessible to users associated with the entity. In block 440, the component retrieves metrics data related to the entity. The metrics data may include, for example, an indication of the entity's performance for each metric relative to other entities (e.g., 95th percentile or “3 of 373”) or a score for the particular metric (e.g., 95 out of 100) based on a scoring system. In some examples, the retrieved metrics data may also include historic ranking as well, such as an indication of the entity's ranking during the previous month, quarter, year, and so on. Furthermore, the facility may enable the user to specify a time period for calculating a ranking (e.g., current quarter, year to date, previous 12 months, the year 2010). In decision block 450, if any performance targets have been established for the entity, then the component continues at block 460 and retrieves the established target data, else the component continues at block 470. In block 470, the component retrieves professional peer data, such as recent comments or best practices materials posted or followed by professional peers. In block 480, the component retrieves groups data, such as new comments posted to the user's group pages, indications of any users recently added to the user's groups, and so on. In some examples, the retrieved comments may be filtered to include only a user's professional peers, friends, and/or co-workers. In block 490, the component assembles the page and then completes. In some cases, the facility may restrict access to information about a particular entity or user based on user privileges. Furthermore, users associated with an entity (e.g., the entity's employees) may have access to more information about the entity than other users. For example, the facility may prevent target performance data for an entity from being displayed to users that are not associated with that entity.

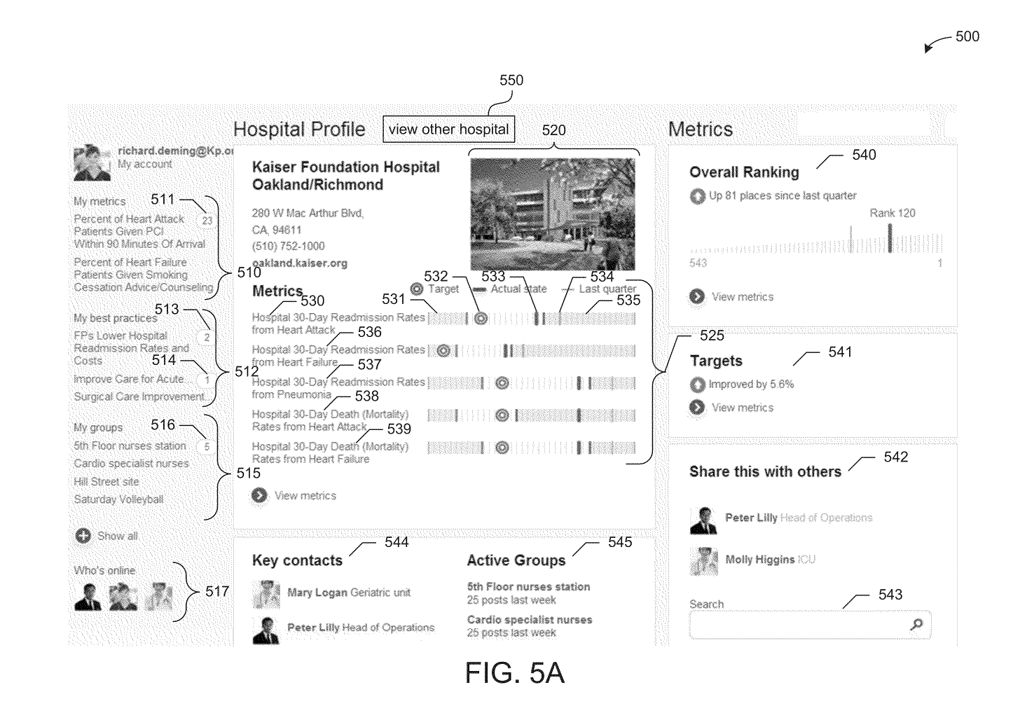

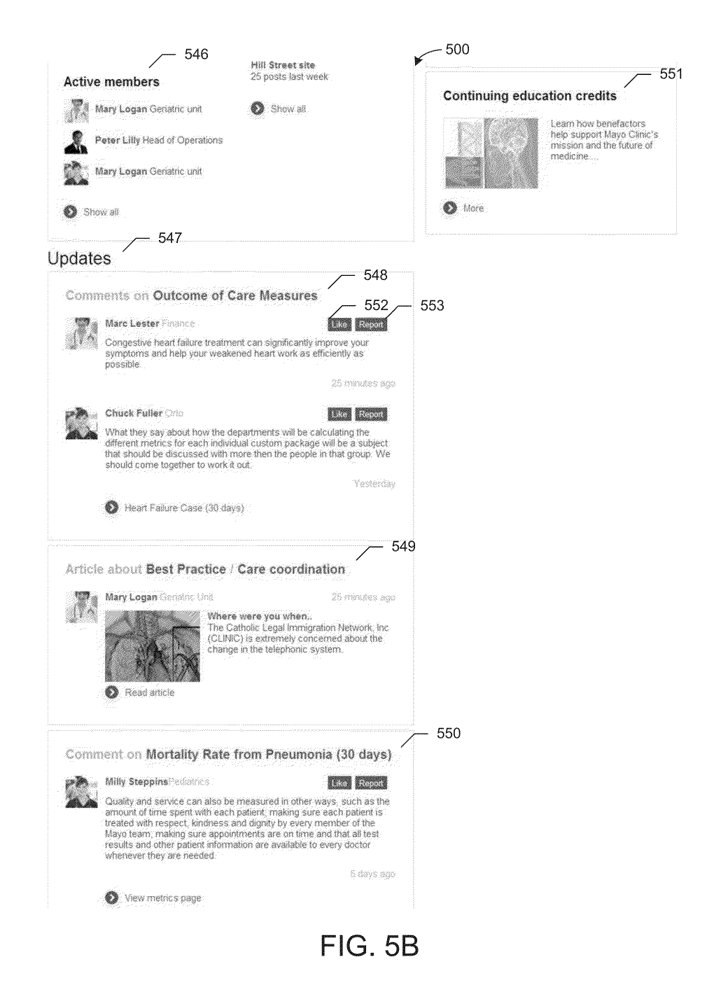

The following paragraphs describe FIGS. 5a-16, which represent display pages generally related to the medical industry (e.g., hospitals, medical facilities). However, one of ordinary skill in the art will recognize that these figures are merely illustrative and that similar display pages can be created for entities related to other industries or professions, such as accounting firms, automotive mechanics, law firms, restaurants, etc.

FIGS. 5a and 5b are display pages illustrating an entity profile page 500 in some examples. Entity profile page 500 includes “My Metrics” section 510, “My Best Practices” section 512, and “My Groups” section 515, each section representing a list of data items that the user has chosen to follow or groups to which the user belongs. For example, the user has chosen to follow the “Percent of Hearth Attack Patients Given PCI Within 90 Minutes of Arrival” metric, best practices for “Surgical Care Improvement,” and so on. Accordingly, the user is presented with the displayed list of links for the followed items along with indications 511, 513, 514, and 516 of the number of new or updated messages related to the followed items. In some examples, entity profile page 500 may also include a list of recent activities that the user has undertaken to achieve a particular goal and/or any goals that the user has set for herself. Entity profile page 500 also includes an indication of other users who are online 517, administrative information 520, and “Metrics” section 525. “Metrics” section 525 includes an indication of various metrics 530, 536, 537, 538, and 539 and an indication of the hospital's performance with respect to each of these metrics. In this example, performance information is provided for each displayed metric, such as metric 530, according to a graph that includes an indication of a top range for the metric designated by shaded region 531 (e.g., rankings of top performers may be shaded in green), the entity's performance target 532 for the metric, the entity's current ranking 533 for the metric, the entity's ranking during the previous quarter 534 for the metric, and a bottom range for the metric designated by shaded region 535 (e.g., rankings of the worst performers may be shaded in red or pink). Similar graphs are provided for metrics 536-539. View other hospital link or button 550 allows the user to select another hospital to view metrics for the selected hospital. For example, in response to clicking the view other hospital link or button 550, the user can be presented with a list of hospitals (e.g., hospitals near the user's current location, hospitals near the user's hospital or place of employment, hospitals that the user has recently search for) and/or a dialog box the user can use to search for hospitals based on name, location, size, and so on. In some examples, the top and bottom ranges correspond to parameters specified by the data provider and may reflect specified percentiles, scores that lie more than a predetermined number of standard deviations from a mean, etc. The facility may select metrics to display based on, for example, entity preferences, user preferences, the entity's top and bottom performers, and so on.

Entity profile page 500 also includes “Overall Ranking” section 540, which provides a composite ranking for the entity based on a number of the metrics for which data has been collected. In this example, the hospital ranks 120 out of 543 hospitals, which in turn represents an improvement of 81 places since the previous quarter. “Targets” section 541 provides an indication of how the hospital has improved (or regressed) since the previous quarter (or other specified period). “Share This With Others” section 542 enables a user to share a particular entity profile page with other users by selecting the appropriate user from a list or by searching for the user by name, job title, entity, etc., via search box 543. In some cases, the facility may prevent or deter a user from sharing pages that include private or privileged information. Alternatively, the facility may remove private or privileged information from a page prior to allowing the page to be shared with another user. “Key Contacts” section 544 includes an indication of users employed by the hospital who are in charge or perform a supervisory role with respect to the hospital or sub-entity within the hospital. “Active Groups” section 545 includes an indication of the user's most active groups over a previous specified period (e.g., the previous week) based on the number of messages exchanged (e.g., top 3, top 5, or those groups for which the number of messages exchanged exceeds a predetermined threshold) and an indication of the number of messages exchanged in each of the active groups over a specified period. Entity profile page 500 also includes an “Active Members” section 546 that includes a list of the most active users over the previous week (or other specified period). The list of active users may be constrained to a user's professional peers, friends, and/or coworkers.

Entity profile page 500 also includes “Updates” section 547, which identifies new comments (e.g. metric-related comments 548 or group-related comments 550) or newly available best practices materials 549 since the user's last login. A user can “Like” or “Favorite” comments or best practices materials by clicking an associated “Like” button (e.g., button 552) and can report improper or otherwise inappropriate comments or best practices materials by clicking an associated “Report” button (e.g., button 553). In some examples, the facility may provide a mechanism that allows users to score the materials based on a scale (e.g., 1 to 100). “Continuing Education Credits” section 551 links to another page for browsing and enrolling in Continuing Education courses.

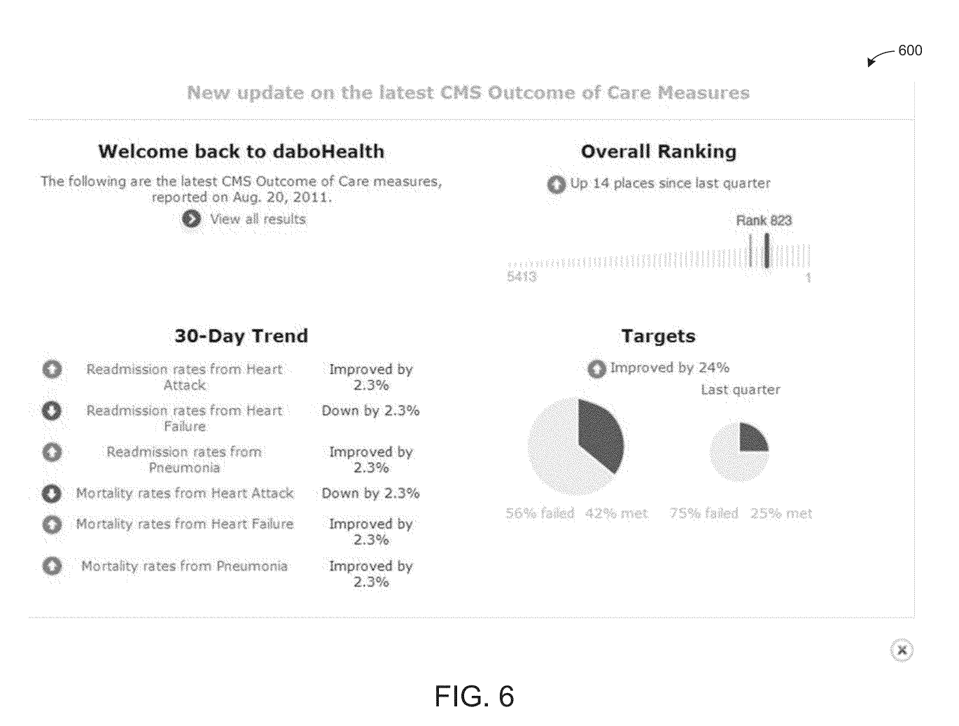

FIG. 6 is a display page illustrating an update splash page 600 in some examples. In this example, the update splash page 600 includes an indication of updated metric data, trend information for various metrics (e.g., how a particular entity has improved over a specified period, such as 30 days), overall ranking information, and targets information.

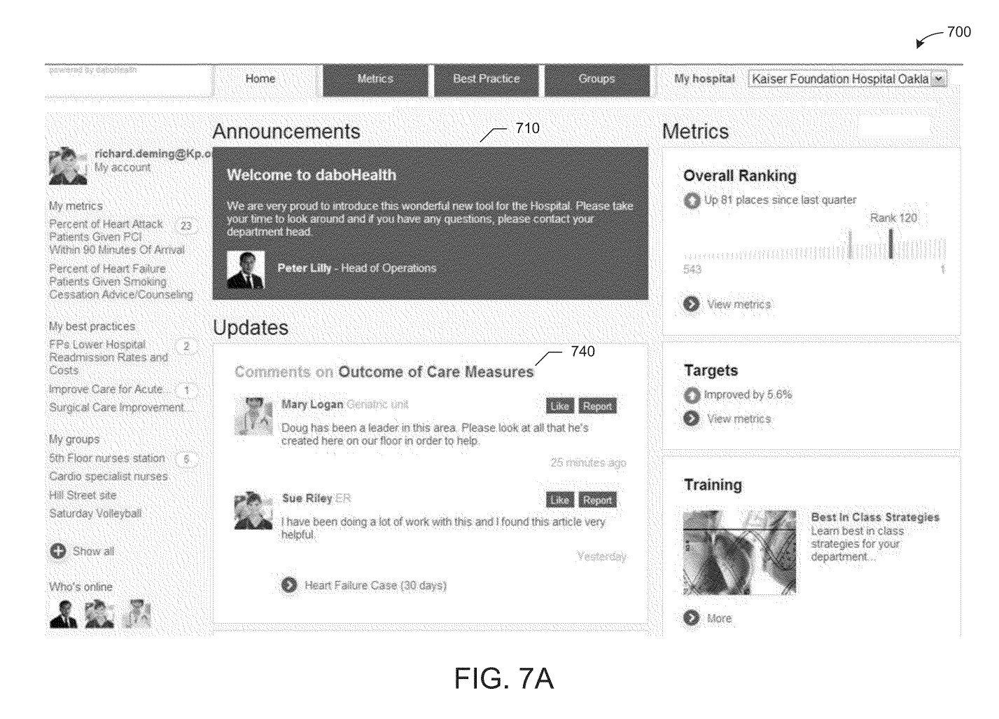

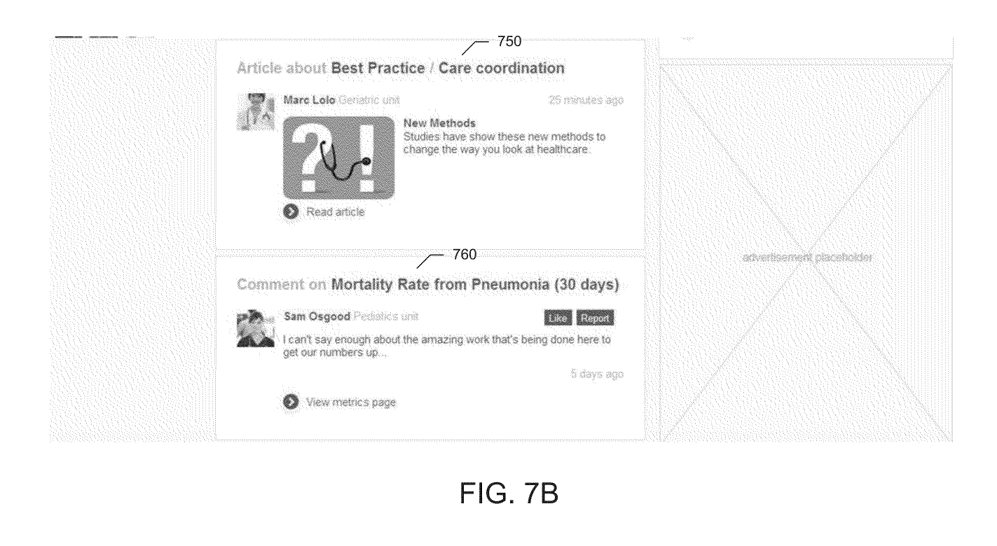

FIGS. 7A and 7B represent a display page illustrating an announcements page 700 in some examples. Announcements page 700 includes an Announcement section 710 that includes a message from the hospital's Head of Operations. Announcements page 700 also includes a favorites section, updates section comprising various subsections relating to metrics 740 and 760 and best practices 750, overall rankings section, targets section, and training section similar to those discussed above.

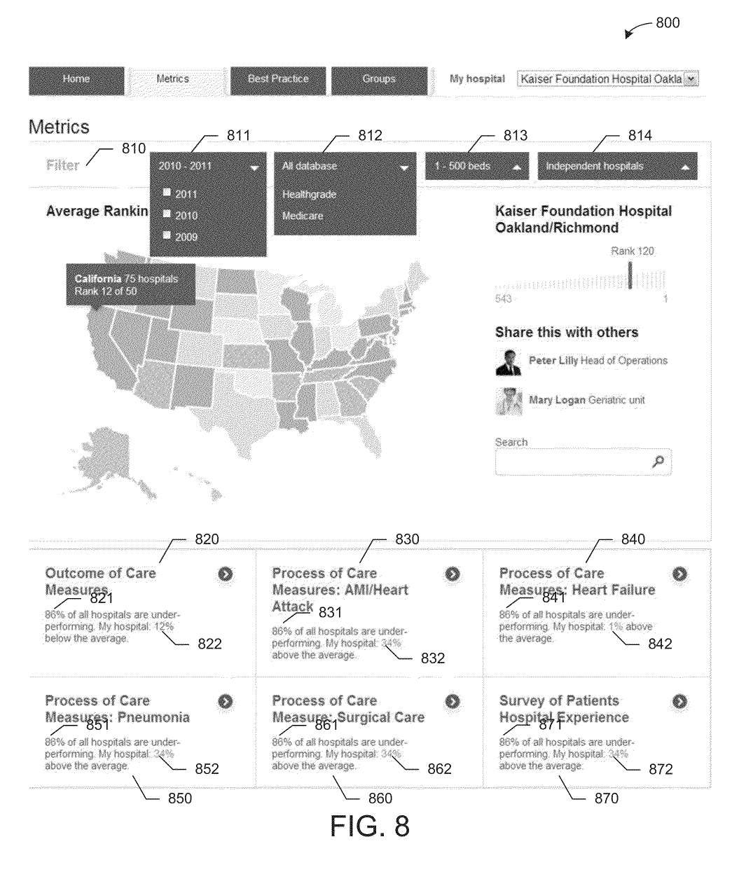

FIG. 8 is a display page illustrating a metrics portal page 800 in some examples. Metrics portal page 800 enables a user to customize the data used to generate performance rankings using filter options 811-814. In this example, a user can customize the years 811 and the databases 812 that the facility uses to generate performance scores and/or rankings. Furthermore, the user can customize the entities that are used for the comparison by, for example, limiting the comparison to industry-specific metrics, such as hospitals with a specified range of beds 813 (e.g., less than 50, 51-150, 151-500, more than 500) and whether the hospital is independent 814. From the metrics portal page 800, a user can obtain a quick snapshot of how other hospitals as well as the user's associated hospital are performing with regard to a number of metrics. In this example, “Outcome of Care Measures” section 820 indicates that 86% of all hospitals are underperforming 821 based on, for example, an average score for that particular metric, a predetermined threshold score, etc., and that the user's hospital is 12% below average for this particular metric 822. Similar information for other metrics is provided in sections 830-870.

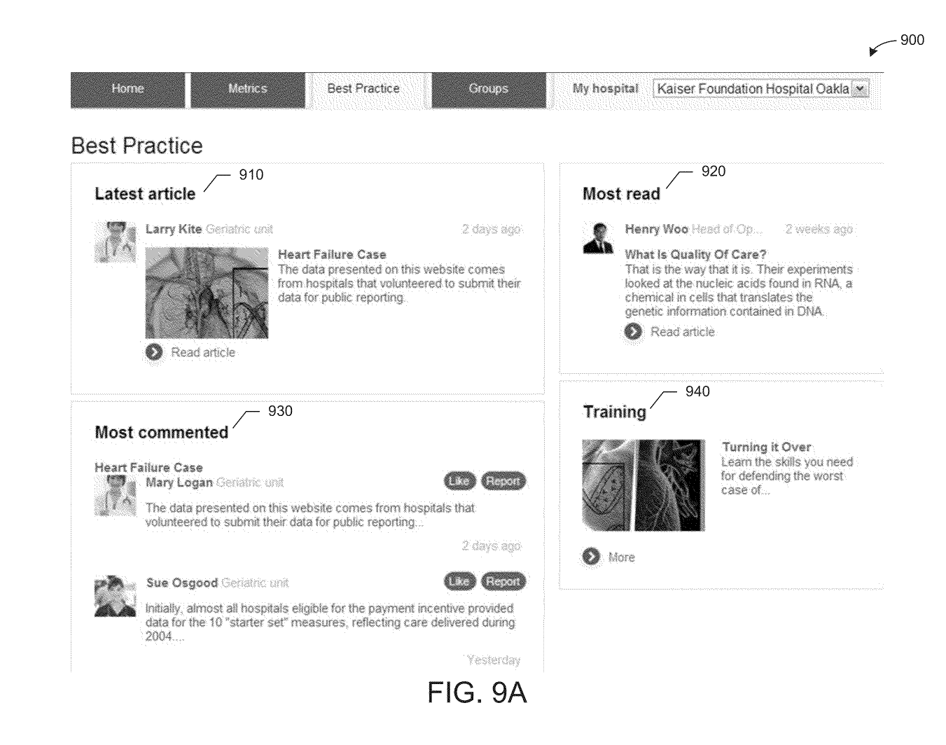

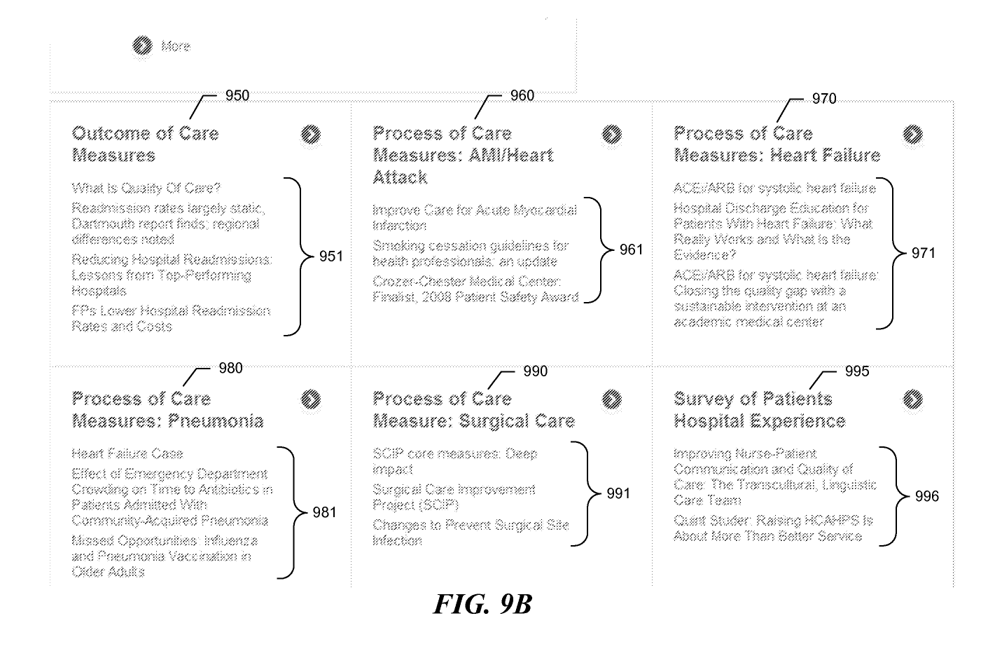

FIGS. 9A and 9B represent a display page illustrating a Best Practices portal page 900 in some examples. Best Practices portal page 900 includes a list 910 of the most recently available best practices materials, a list 920 of the most read best practices materials, a list 930 of the most commented best practices materials and related comments, and a link 940 to training materials. Furthermore, Best Practices portal page 900 includes metric sections 950, 960, 970, 980, 990, and 995, which include links to metric pages and links 951, 961, 971, 981, 991, and 996 to related best practices materials.

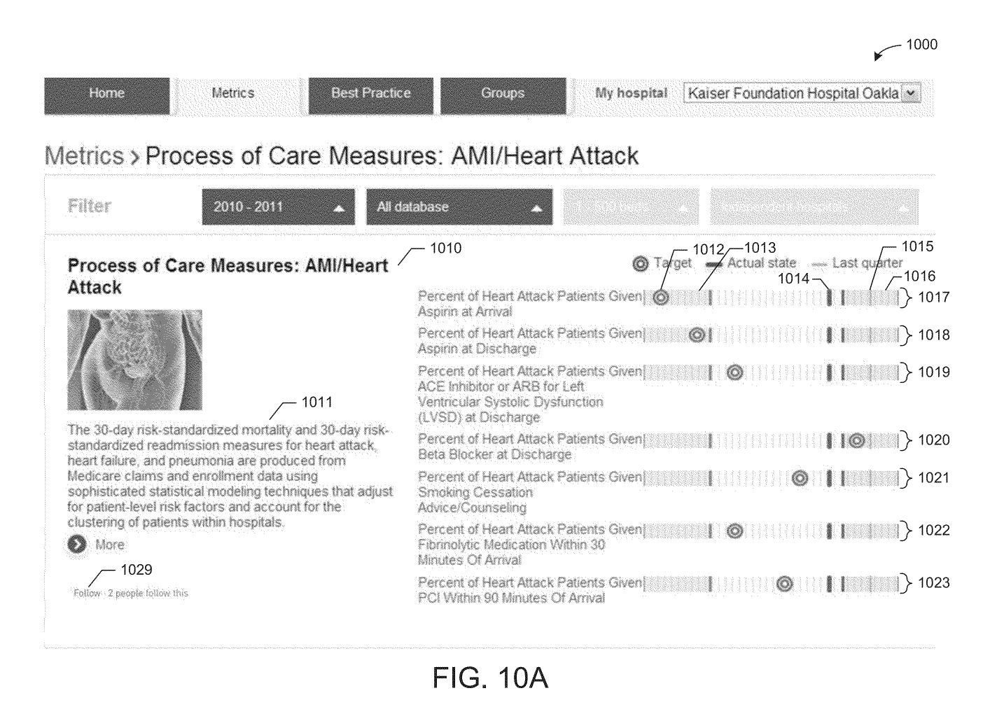

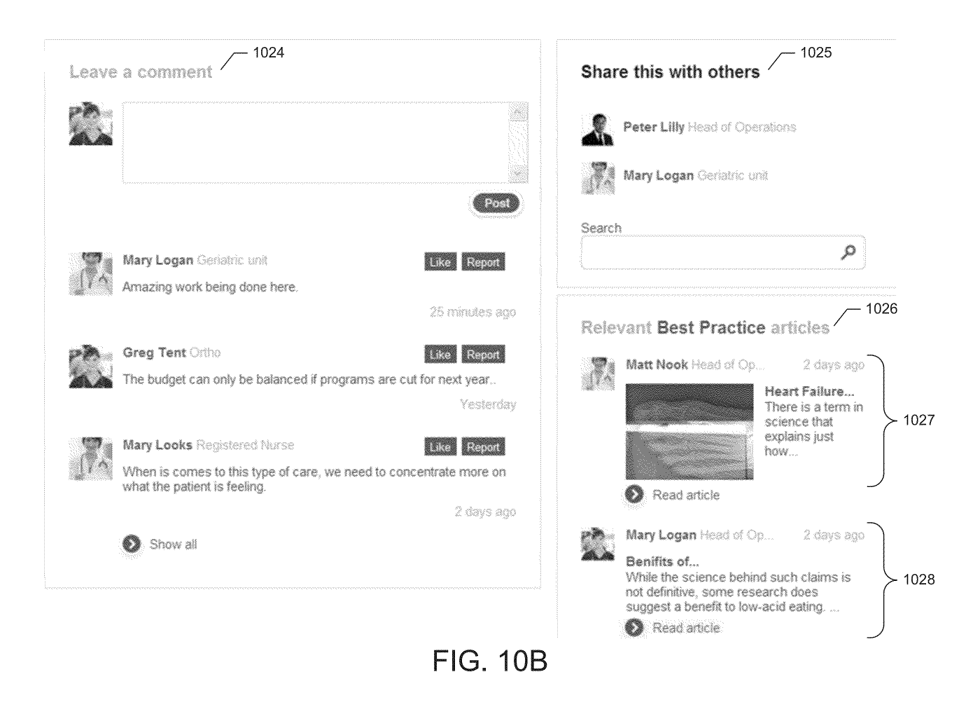

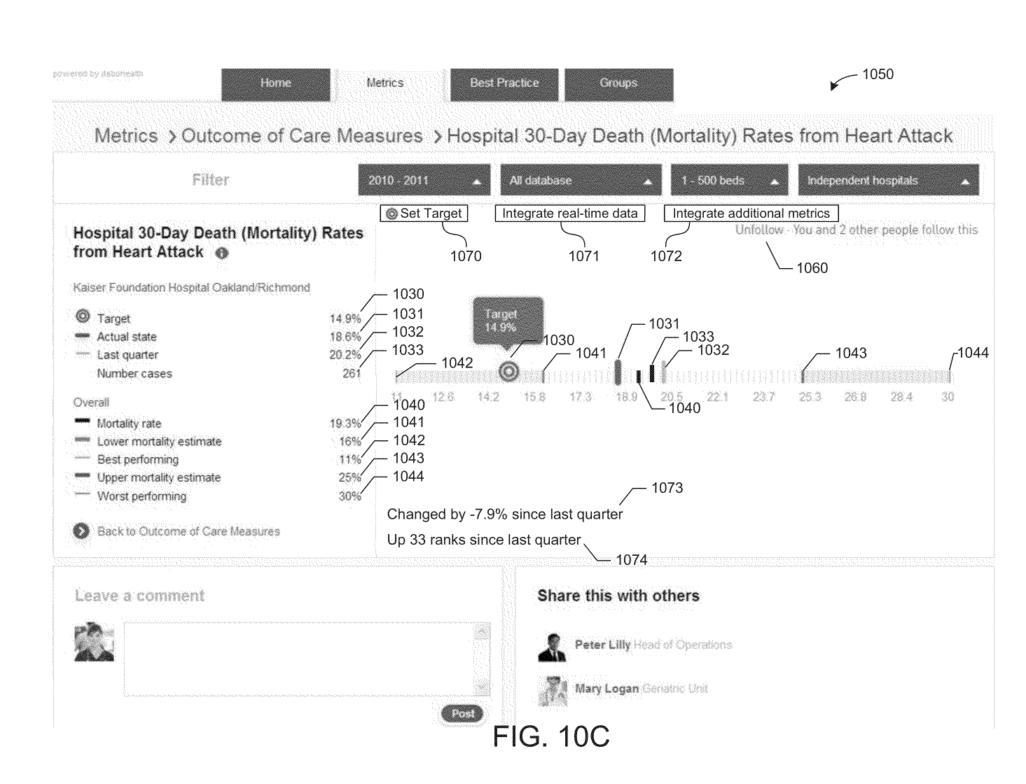

FIGS. 10A and 10B represent a display page illustrating a composite metric page 1000 in some examples. In this example, composite metric page 1000 includes information related to a “Process of Care Measures: AMI/Heart Attack” composite metric 1010 comprised of various metrics 1017-1023. Furthermore, a brief description 1011 of the metric is included, which may be retrieved from the source of the data for the metric. In some cases, the facility may provide a link to additional details about the metric. For the “Percent of Heart Attack Patients Given Aspirin at Arrival” metric 1017, composite metric page 1000 includes an indication of a top range for the metric designated by shaded region 1013, the entity's performance target 1012 for the metric, the entity's current ranking 1014 for the metric, the entity's ranking during the previous quarter 1015 for the metric, and a bottom range for the metric designated by shaded region 1016. Composite metric page 1000 includes similar information for each of metrics 1018-1023. Composite metric page 1000 also includes comments section 1024 where users can post comments related to the metric and share section 1025 which enables users to share the composite metric page with others. Furthermore, composite metric page 1000 also includes Best Practices section 1026, which includes links to best practices materials related to metric 1010, such as articles 1027 and 1028, and follow link 1029 which allows a user to select to follow the composite metric 1010. In this manner, a user can identify relevant best practices materials for a particular metric of interest to the user. Furthermore, the facility can present the best practices materials and display the materials in order of ranking. A best practices article can be assigned a score based on, for example, the number of times users have “liked” or “shared” the article, various user attributes (e.g., the user's years of experience, the user's job title, the performance ranking of the user's associated entity or sub-entity for the related metric, the user's education level, distinctions, fellowships), and the amount of time since the user “shared” or “liked” the article. In this manner, crowd-sourcing techniques can be used to identify the most reliable or respected best practices materials for a given metric. Accordingly, the facility enables the user to quickly identify best practices materials that will help them improve their rankings for various metrics of interest. Furthermore, the facility may rank authors according to the scores or rankings of the best practices materials that they provide and use these author rankings to generate a score for the best practices materials. In some embodiments, a page may include an indication of users who have “liked” a particular piece of information displayed on that page. For example, page 1000 may include a list of users who have “liked” each article, such as article 1027. If the number of users who have liked the article exceeds a predetermined threshold (e.g., 35 users), then page 1000 may display the number of users who have liked the article. Furthermore, if a user moves a mouse pointer over (or near) a link or image associated with the article or clicks on the link or image, the facility may display, for example, a complete list of users who have liked the article, a list of users associated with the user's associated entity (e.g., place of employment) who have liked the article, a list of other users who belong to groups to which the user belongs, and so on.

FIG. 10C is a display page illustrating a metric page 1050 in some examples. In this example, metric page 1050 includes information related to a “Hospital 30-Day Death (Mortality) Rates from Heart Attack” metric. Metric page 1050 includes relevant information collected from one or more sources about a specific hospital along with overall information pertaining to the metric (e.g., relevant data collected for the metric about multiple hospitals). For example, metric page 1050 includes an indication of the hospital's performance target 1030 for the metric, the hospital's actual state or current ranking 1031 for the metric, the hospital's ranking during the previous quarter 1032 for the metric, and the number of relevant cases 1033 treated or overseen by the hospital. Metric page 1050 also includes overall information for the metric including an indication of the average mortality rate 1040 for the relevant hospitals, a lower mortality estimate (i.e., worst) 1041 for the top performing hospitals, the highest (i.e., best) mortality rate 1042 across the relevant hospitals, an upper mortality estimate (i.e., best) 1043 for the bottom performing hospitals, and the lowest (i.e., worst) mortality rate 1044 across the relevant hospitals. Metric page 1050 also includes “Unfollow” link 1060 which allows a user to select to “unfollow” the metric. Set Target link or button 1070 directs the user to a page or dialog box the user can use to create a target for a particular metric. The target may be specific to the user, the user's group within the hospital, or the hospital itself. For example, a hospital administrator may set a particular target for the hospital while a group administrator may set an even higher target for a particular metric. The metric page may display multiple targets. For example, if a user is in the group administrator's group, the metric page can include an indication of the group administrator's target, the hospital administrator's target, and any personal target set for the user by the user. Integrate real-time data link or button 1071 directs the user to page or dialog box the user can use to update previously-retrieved metric data with new data collected by the hospital or from another entity. For example, data about different metrics (e.g., mortality rate) from data.medicare.org, healthgrades.com, etc. can be supplemented with daily or weekly data collected by the hospital between updates from those other sources (e.g., data.medicare.org and healthgrades.com). In this manner, the hospital employees can use the facility to monitor its performance with respect to various metrics in real-time. Integrate additional metrics link or button 1072 directs the user to a page or dialog box the user can use create a new metric and provide data for that metric. For example, data collected data.medicare.org, healthgrades.com, etc. may not include data for a particular metric that a hospital staff is interested in monitoring. The integrate additional metrics allows hospital employees to create the metric, provide data for the metric, assess performance with respect to the metric, and share the metric with other users and hospitals. The other users and hospitals may be encouraged to provide data for that metric as well so that performance of different hospitals with respect to the new metric can be compared. Metric label 1073 provides an indication of the percentage change in the metric for the hospital since a previous period, such as last week, last quarter, last month, and so on. In this case, Kaiser Foundation Hospital Oakland/Richmond's 30-Day Death (Mortality) Rate from Heart Attack has decreased from 20.2% to 18.6% since last quarter, a relative change of −7.9% of the original mortality rate. In some examples, the facility may express this change as an absolute change in the mortality rate (i.e., 1.6%). Metric label 1074 provides an indication of change in ranking for the hospital since a previous period. In this case, the hospitals ranking has increased 33 ranks since the previous quarter.

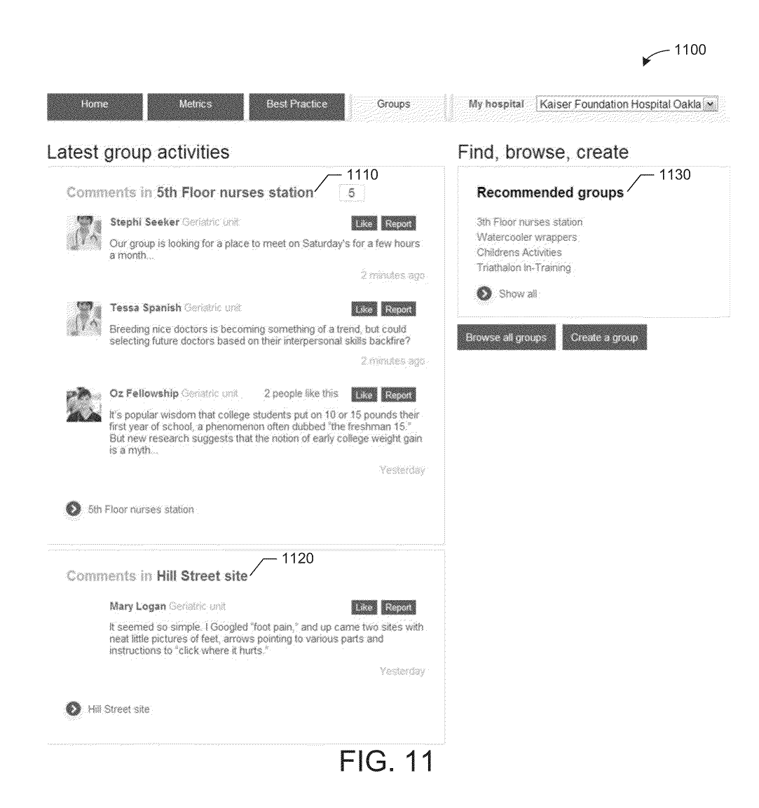

FIG. 11 is a display page illustrating a groups page 1100 in some examples. A groups page enables a user to view information related the groups to which the user belongs and further enables a user to search for and/or create groups. The facility may automatically add users to groups based on, for example, common job title, common workplace, common floor, an association with a particular committee or sub-committee, and so on. Furthermore, users may create ad hoc groups to establish a place where a set of users can share information and ideas. Groups may be open (i.e., accessible by any user) or closed (i.e., limited to a select group of users or requiring special permission to join). In this manner, groups of users who are aware of or have access to particular confidential and/or legally privileged information may establish a closed group where they can share private information among themselves. Groups page 1100 includes comments sections that are related to each of the groups to which the user belongs (e.g., “5th Floor Nurses Station” group 1110 and “Hill Street Site” group 1120). For each group, the groups page 1100 includes a list of comments that members of the group contribute to the group. Groups page 1100 further includes a “Recommended Groups” section 1130 that includes a list of groups that may be of interest to the user based on, for example, common items followed by the user and users of a group, the user's proximity to users of a group, and other commonalities between the user and users of a group.

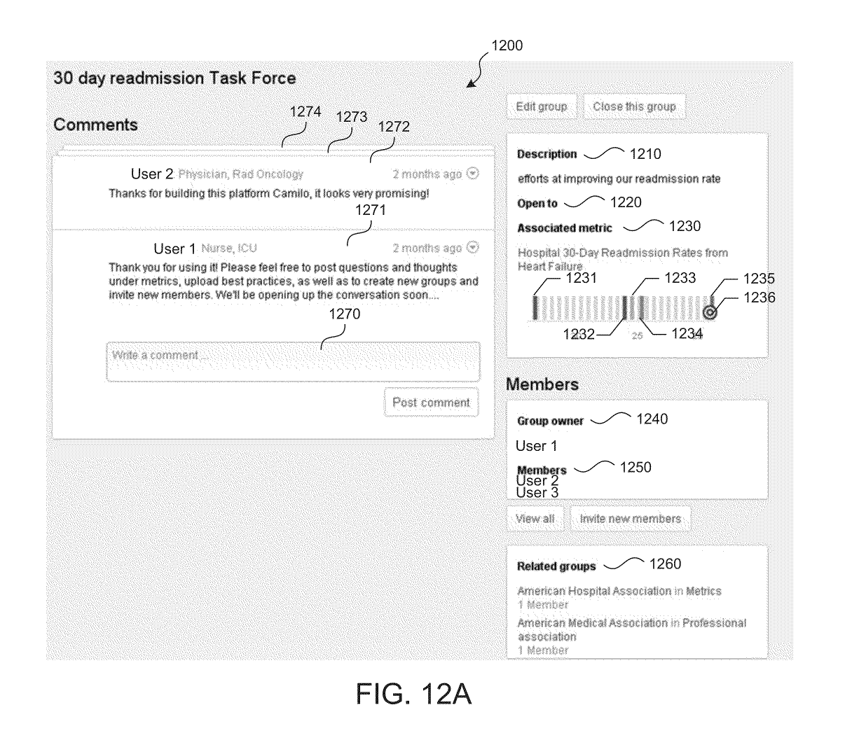

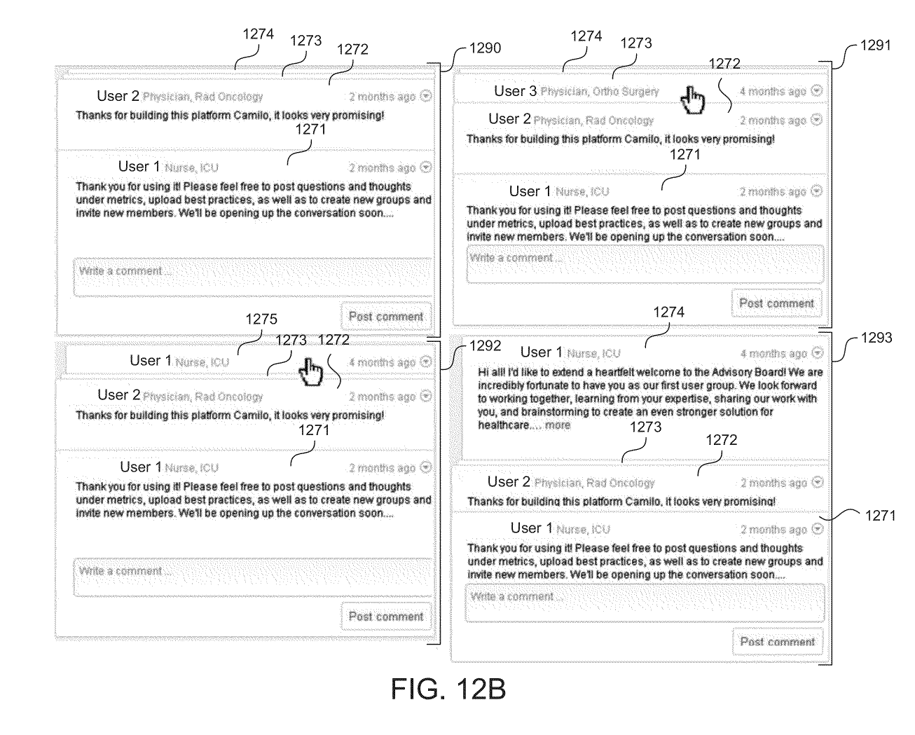

FIG. 12 is a display page illustrating a metric group comments page 1200 in some examples. A metric group comments page enables users to create a discussion group for discussing a particular metric. In this example, metric group comments page 1200 includes description section 1210, “open to” section 1220, associated metric section 1230, group owner section 1240, members section 1250, related groups section 1260, comment box 1270, and discussion panels 1271-1274. Description section 1210 provides a brief description of the topic of the comments page. A group owner or a user who creates the group may provide this description. “Open to” section 1220 provides a list of users to whom the metric group comments page is open to add comments. Associated metric section 1230 identifies the metric for which the metric comments pages was created, in this case “30-Day Readmission Rates from Heart Failure.” The associated metric section also includes a graphical display of rankings for the metric, including, for example, an indication 1231 of the ranking of the worst performing entity, an indication 1232 of the current ranking of the current user's hospital, an indication 1233 of a previous ranking (e.g., last week, last month, last quarter, last year) of the current user's hospital, an indication 1234 of an average value for the metric across multiple entities, an indication 1235 of the ranking of the best performing entity, and an indication 1236 of a target ranking. The owner typically has administrative privileges with respect to the page (e.g., the ability to block users, edit/remove comments, or remove the page). In some examples, the graphical display may represent performance metric scores instead of, or in addition to, metric rankings. Group owner section 1240 identifies the owner of the metric group comments page. Members section 1250 identifies members of the group. Related groups section 1260 provides a list of groups related to the metric group based on, for example, similar members (e.g., more than a threshold number or percentage of identical users) or other metric group pages for the same metric. Comment box 1270 provides a text entry box where a user can enter a new comment for submission. Each of discussion panels 1271-1274 represents a comment or a submission from a user and associated information. For example, each discussion panel may include an indication of the user (e.g., name, picture, nickname), an indication of their associated hospital (if any), an indication of their profession, an indication of when the associated comment was submitted (e.g., time/date or duration since the comment was submitted), and the comment itself. In some embodiments, the discussion panels are stacked and configured to move in response to user interactions. Examples of these movements are provided in FIG. 12B.

FIG. 12B provides illustrations representative of the dynamic movement of a discussion panel stack in response to user interactions with the discussion panel stack in some examples. In each of discussion panel stacks 1290-1293, at least a portion of each of discussion panels 1271-1274 is displayed. For example, in discussion panel stack 1290, each of discussion panels 1271 and 1272 is displayed so that the comment and related information are displayed in their entirety wherein as only a top portion of each of discussion panels 1273 and 1274 is displayed. Thus, the two most recent comments are displayed whereas the rest of the comments are hidden. One skilled in the art will recognize that any number of panels may be hidden or displayed. For example, a discussion panel stack may include the display of 1, 5, 10, 100, or more entire panels and any number of “hidden” or slightly exposed panels. A discussion panel stack may be configured to automatically expose comments and associated information based on, for example, the time at which the related comments were posted. For example, a discussion panel stack may be configured to automatically expose the five most recent comments and associated information, the ten most “liked” comments and associated information, or all comments and associated information from specific user types (e.g., group owner, administrators, most active group members), and so on. One skilled in the art will recognize that although the examples above include specific numbers of automatically exposed comments, any number of comments may be automatically exposed. The discussion panel stack may then be further modified in response to user interactions.

In discussion panel stack 1291, after the user has interacted with discussion panel 1273 (e.g., by moving a mouse pointer over the discussion panel, holding the mouse pointer over the discussion panel for at least threshold period (e.g., 1 second, 2 seconds), or clicking on the discussion panel), the discussion panel stack is modified by sliding each of discussion panels 1271 and 1272 down to expose an additional portion of discussion panel 1273 while only the top portion of discussion panel 1274 remains exposed. In this example, identification information for the user who posted the comment associated with discussion panel 1273 along with their profession and an indication of when the comment was posted is exposed.

In discussion panel stack 1292, after the user has interacted with discussion panel 1274, the discussion panel stack is modified by sliding each of discussion panels 1271-1273 down to expose an additional portion of discussion panel 1274 while only the top portion of discussion panel 1273 remains exposed. In this example, identification information for the user who posted the comment associated with discussion panel 1274 along with their profession and an indication of when the comment was posted is exposed.

In discussion panel stack 1293, after the user has interacted with discussion panel 1274, the discussion panel stack is modified by sliding each of discussion panels 1271-1273 down to expose an additional portion of discussion panel 1274 while only the top portion of discussion panel 1273 remains exposed. In this example, the comment associated with discussion panel 1274 is exposed. In some examples, a discussion panel may be slightly exposed in response to a first user interaction, such as a rollover, and then further exposed in response to an additional user interaction, such as clicking on the discussion panel or holding the mouse pointer over the panel for a predetermined period of time. Furthermore, exposed panels may be “hidden” or collapsed in response to similar user interactions. For example, a discussion panel with an exposed comment may be collapsed in response to a user clicking on the discussion panel.

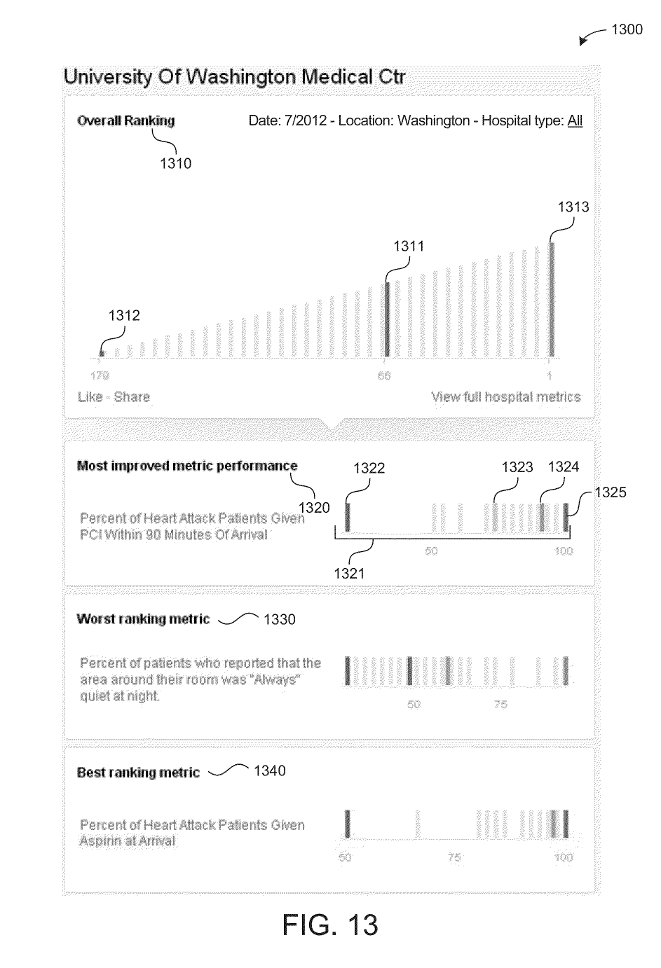

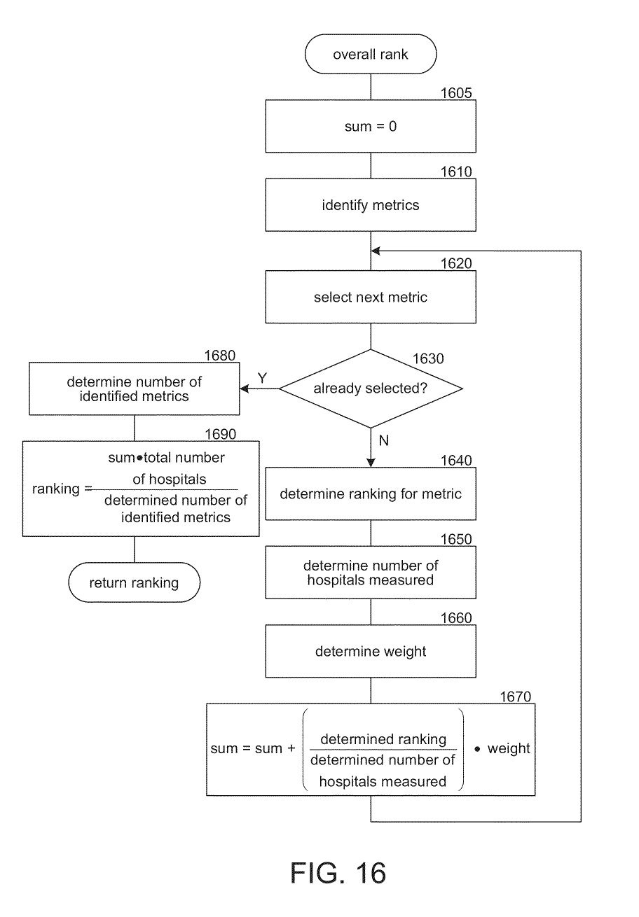

FIG. 13 is a display page representing a portion of a hospital profile page 1300 in some examples. In this example, the hospital page includes an overall ranking section 1310, which includes an indication 1311 of the overall ranking of the hospital with respect to a group of hospitals, an indication 1312 of the lowest ranking hospital with respect to the group of hospitals, and an indication 1313 of the highest ranking hospital with respect to the group of hospitals. One technique for calculating an overall ranking is further discussed below with respect to FIG. 16. The group of hospitals can be defined by the user by selecting a geographic region and/or hospital type, such as all hospitals in a particular city, county, state, or country and/or all hospitals that specialize in treating children. In this example, the group of hospitals is all hospitals in Washington State (for which data has been collected). The current hospital (i.e., a currently selected hospital, such as the user's hospital, in this example, the University of Washington Medical Center), currently has an overall rank of 66 of 179 among the hospitals in Washington state. In some embodiments, the rank of the current hospital can be displayed relative to hospitals another geographic area, include an area that does not include the current hospital. For example, the University of Washington Medical Center, which is in Washington State, can be compared to hospitals in California by changing the selected “Location” to California. The hospital page further includes a most improved metric performance section 1320, a worst ranking metric section 1330, and a best ranking metric section 1340. Most improved metric performance section 1320 identifies the metric for which the current hospital has improved the most in ranking relative to the selected group of hospitals from a previous period to a current period. Metric chart 1321 includes an indication 1324 of the current hospital's current ranking for the most improved metric, an indication 1323 of the hospital's ranking during the previous period, an indication 1325 of the highest ranking hospital, and an indication 1322 of the lowest ranking hospital. Worst ranking metric section 1330 identifies the metric for which the hospital has its lowest ranking among the selected group of hospitals. Best ranking metric section 1340 identifies the metric for which the hospital has its highest ranking among the selected group of hospitals.

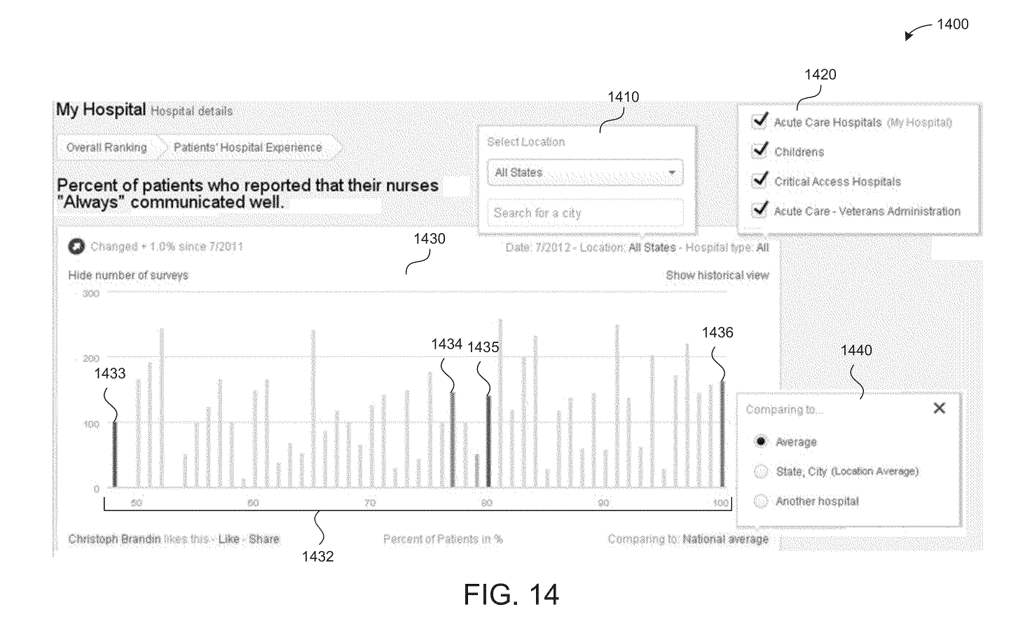

FIG. 14 is a display page illustrating a metric performance ranking page 1400 in some examples. The metric performance ranking page provides an indication of a selected hospital's (e.g., the user's hospital) score and relative ranking for a metric with respect to a group of hospitals for a particular metric. A user may specify the group of hospitals by, for example, specifying a location (e.g., city, county, state, country) via dialog box 1410, specifying a hospital type via dialog box 1420, and so on. Metric chart section 1430 provides a visual representation of the current hospital's score and rank relative to the selected group of hospitals. Metric chart 1430 includes an indication 1435 of the current hospital's current score and ranking among the group of hospitals, an indication 1433 of the lowest-ranked hospital's (i.e., the worst performing hospital) score and relative ranking, an indication 1436 of the highest-ranked hospital's (i.e., the best performing hospital) score and relative ranking. Metric chart 1430 also includes an indication 1434 of a benchmark score and ranking selected using dialog box 1440. The benchmark may correspond to, for example, an “Average” value, corresponding to the average score for the metric among the selected group of hospitals, a Location Average, corresponding to the average score for the metric for a selected geographic location, the score for another hospital selected, for example, by the user, and so on. In this example, each hospital is represented by a bar in a bar chart in which the height of the bar represents the number or volume of surveys with responses for the relevant metric (in this case, Percent of patients who reported that their nurses “Always” communicated well) that have been collected for the hospital (i.e., reported cases). For example, the highest-ranking hospital had approximately 158 reported cases, the lowest-ranked hospital had approximately 100 reported cases, and the selected hospital had approximately 142 reported cases.

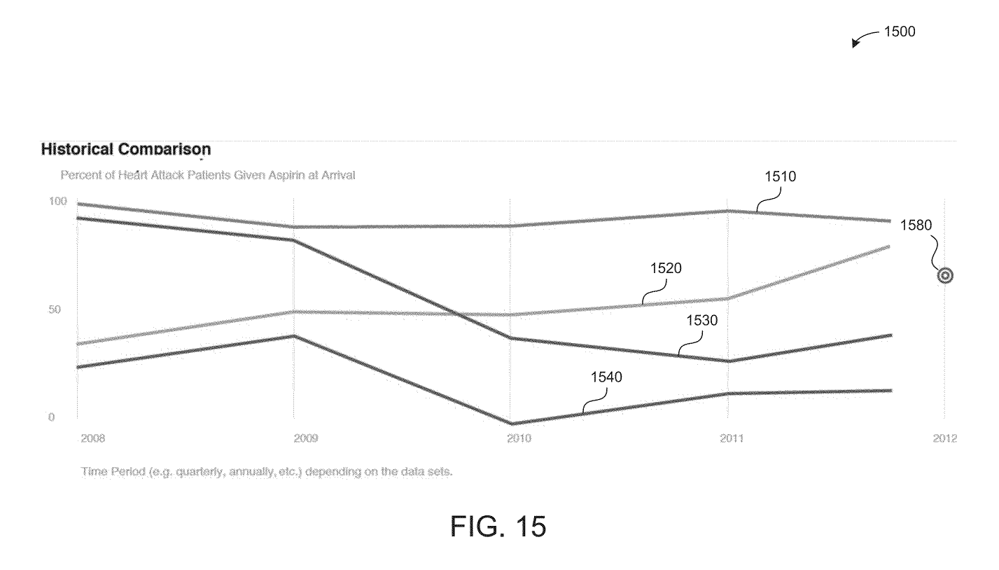

FIG. 15 is a display page illustrating a historical information page 1500 for a metric in some examples. In this example, historical information page 1500 represents past and current scores for a “Percent of Heart Attack Patients Given Aspirin at Arrival” metric and includes an indication of the highest score for the metric over time, the lowest score for the metric over time, the benchmark score over time, and a score for a selected hospital over time. Line 1510 represents the highest score for the metric over time, which may be attributed to different hospitals over that time period. For example, at the beginning of 2008, the highest score was approximately 100 (percent) while the highest score at the beginning of 2010 was approximately 90. Line 1540 represents the lowest score for the metric over time, which may be attributed to different hospitals over that time period. For example, at the beginning of 2010, the lowest score was approximately 0 while the lowest score at the beginning of 2011 was approximately 10. Line 1530 represents the score for the current selected hospital (e.g., the user's hospital) over time while line 1520 represents the benchmark score (e.g., an average score for a selected group of hospitals, an average score for a selected geographic area, or the score for another hospital) over time. Target marker 1550 represents the goal or target for the selected hospital. In some embodiments, the historical information page may include, for each of multiple points in time, a target marker corresponding to that point in time. Thus, if the target has changed over time, the historical information page can provide an indication of the hospital's performance relative to the target over time.

FIG. 16 is a block diagram illustrating the processing of an overall ranking component in some examples. The overall ranking component is invoked by the facility to generate an overall ranking for a particular hospital. In block 1605, the component initializes sum to 0. In block 1610, the component identifies metrics for which data has been collected for the particular hospital. In block 1620, the component selects the next metric. In decision block 1630, if the selected metric has already been selected, then the component continues at block 1680, else the component continues at block 1640. In block 1640, the component determines a ranking for the particular hospital for the selected metric relative to a group of hospitals, such as all hospitals within a selected state and for which the facility has collected data for the selected metric. In block 1650, the component determines the number of hospitals in the group of hospitals. In block 1660, the component determines a weight for the selected metric. A user or an administrator of the facility may determine the weight, which is representative of the importance of the metric with respect to an overall ranking. For example, a user may consider Mortality Rate to be more important to ranking hospitals than “Percent of patients who reported that their nurses ‘Always’ communicated well and assign “Mortality Rate” a higher weight than “Percent of patients who reported that their nurses “Always” communicated well.” In block 1670, the component multiplies

$$( \frac{determined ranking ( block 1640 )}{determined number of hospitals ( block 1650 )} )$$

by the determined weight (block 1660), adds the product to sum, and then loops back to block 1620 to select the next metric. In block 1680, the component determines the number of identified metrics. In block 1690, the component calculates a ranking by multiplying sum by the total number of hospitals and divides the product by the number of identified metrics determined in block 1680. The component then returns the calculated ranking. In some embodiments, once an overall ranking has been calculated for all hospitals within a selected group of hospitals, the facility may scale the overall rankings based on the hospital in the selected group with the best (lowest) overall ranking. Thus, if the hospital with the best overall ranking has an overall ranking of 2.1, the facility may adjust all overall rankings for hospitals in the selected group by subtracting 1.1 (or divided by 2.1) so that the best hospital has a ranking of 1. In some embodiments, the facility may treat the “overall ranking” as a score and assign cardinal rankings to the “scores” from 1 to the number of hospitals in the selected group of hospitals.

From the foregoing, it will be appreciated that specific embodiments of the technology have been described herein for purposes of illustration, but that various modifications may be made without deviating from the disclosure. For example, similar technology can be used in the context of other industries. Additionally, while advantages associated with certain embodiments of the new technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Although the subject matter has been described in language specific to structural features and/or methodological acts, it is to be understood that the disclosed subject matter is not necessarily limited to the specific features or acts described above. Rather, the specific features and acts described above are disclosed as example forms of the disclosed technology.

I/we claim:

1. A method for assessing performance metrics and socializing best practices information comprising:
receiving, from each of a plurality of sources, performance metric data for each of a plurality of entities;
receiving, from each of a plurality of sources, best practices materials related to each of a plurality of performance metrics;
for each of a plurality of performances metrics, ranking each of the plurality of entities based on the performance metric data;
in response to receiving a request to access performance metrics data,
identifying a first entity associated with the user based at least in part on an email address associated with the user,
identifying professional peers of the user based at least in part on a job title associated with the user,
for each of a plurality of performance metrics, determining a rank for the first entity relative to other entities,
generating a first display page comprising an indication of the determined ranks and an indication of the identified professional peers, and
transmitting for display to the user the generated first display page; and
in response to receiving from the user a request to access performance data associated with a first performance metric,
identifying best practices materials associated with the first performance metric,
for each of the identified best practices materials, assigning a score to the best practices material based at least in part on the number of times that the best practices material has been shared,
ranking the identified best practices materials based on the assigned scores, and
generating a second display page comprising an indication of the performance of the first entity for the first performance metric and an indication of the highest ranked best practices material of the identified best practices materials.

2. The method of claim 1, further comprising:
generating a third display page for the first performance metric, the third display page comprising comments related to the first performance metric and a graphical representation of the performance of a plurality of entities with respect to the first performance metric.

3. The method of claim 2, wherein each of the comments is displayed in a separate panel of a panel stack wherein at least one panel stack is configured to be moved in response to being selected by the user.

4. The method of claim 1, wherein receiving performance metric data for a first entity comprises, receiving, for each of a plurality of services provided by the first entity, a success rate for the service provided.

5. The method of claim 1, wherein each of the plurality of entities is a medical facility.

6. The method of claim 1, further comprising:
in response to receiving from the user a request to access a profile page for the first entity, calculating an overall ranking for the first entity relative to a group of entities at least in part by,
identifying a plurality of performance metrics, and
for each of the identified plurality of performance metrics,
determining a rank of the first entity for the performance metric,
determining a number of entities having a score for the performance metric,
determining a weight for the performance metric, and
calculating a score based on the determined rank, the determined number of entities, and the determined weight;
calculating the overall ranking based on a sum of the calculated scores, the total number of entities in the group of entities, and the total number of identified metrics.

7. A computing system having a processor, the computing system comprising:
a component configured to receive performance data for each of a plurality of entities from a first data source;
a component configured to rank the plurality of entities according to each of a plurality of performance metrics;
a component configured to associate best practices materials with each of a plurality of performance metrics; and
a component configured to, in response to receiving a request from a user to access performance data for a first entity,
for each of a plurality of performance metrics,
determine a rank of the first entity for the performance metric,
identify performance metric targets defined for the first entity for the performance metric, and
identify best practices materials for the performance metric, and generate a first display page comprising an indication of the determined
ranks, an indication of identified performance metric targets, and an
indication of the identified best practices materials.

8. The computing system of claim 7, further comprising:
a component configured to rank the identified best practices materials at least in part by,
for each of the identified best practices materials,
determining the number of times that the best practices material has been liked,
for each user that liked the identified best practices material, determining a job title associated with that user, and
ranking the best practices materials based at least in part on the determined number of times that each practices materials have been liked and the determined job titles.

9. The computing system of claim 7, further comprising:
a component configured to determine a rank of a first entity for a first performance metric during a previous period;
a component configured to determine a rank of the first entity for the first performance metric during a current period;
a component configured to generate a second display page comprising an indication of the determined rank of the first entity for the first performance metric during the previous period, an indication of the determined rank of the first entity for the first performance metric during the current period, an indication of the highest-performing entity, and an indication of the lowest-performing entity.

10. The computing system of claim 7, wherein the component configured to receive performance data for each of a plurality of entities from the first data source is configured to receive an indication of the number of times that the first entity failed to comply with regulatory guidelines.

11. The computing system of claim 7, wherein each of the plurality of entities is a medical facility.

12. The computing system of claim 7, further comprising:
a component configured to generate a second display page for a first performance metric, the second display page comprising comments related to the first performance metric and a graphical representation of the performance of a plurality of entities with respect to the performance metric.

13. The computing system of claim 12, wherein the graphical representation of the performance of a plurality of entities with respect to the performance metric comprises, for each of a plurality of entities, an indication of a number of reported cases corresponding to the performance metric.

14. A computer-readable storage medium storing instructions that, if executed by a computing system, cause the computing system to perform operations comprising:
receiving performance data for at least one of a plurality of entities from a first data source;
ranking the plurality of entities according to at least one of a plurality of performance metrics;
associating best practices materials with at least one of a plurality of performance metrics; and
in response to receiving a request from a user to access performance data for a first entity,
for at least one of a plurality of performance metrics, determining a rank of the first entity for the performance metric, and identifying best practices materials for the performance metric, and
generating a first display page comprising an indication of the determined ranks and an indication of the identified best practices materials.

15. The computer-readable storage medium of claim 14, the operations further comprising:
for at least one of a plurality of performance metrics,
determining a first rank of the first entity for the performance metric during a first period, and
determining a second rank of the first entity for the performance metric during a second period;
identifying the performance metric for which the first entity had the largest improvement from the first period to the second period; and
generating a second display page comprising an indication of the identified performance metric for which the first entity had the largest improvement from the first period to the second period.

16. The computer-readable storage medium of claim 14, the operations further comprising:
identifying, from among the plurality of performance metrics, the performance metric for which the first entity has the highest ranking;
identifying, from among the plurality of performance metrics, the performance metric for which the first entity has the lowest ranking;
generating a second display page comprising an indication of the identified performance metric for which the first entity has the lowest ranking and an indication of the identified performance metric for which the first entity has the highest ranking.

17. The computer-readable storage medium of claim 14, wherein each of the plurality of entities is a hospital.

18. The computer-readable storage medium of claim 14, the operations further comprising:
generating a second display page for a first performance metric, the second display page comprising comments related to the first performance metric and a graphical representation of the performance of a plurality of entities with respect to the performance metric.

19. The computer-readable storage medium of claim 18, wherein the graphical representation of the performance of a plurality of entities with respect to the performance metric comprises an indication of a lowest performing entity, an indication of a highest performing entity, and an indication of a benchmark score.

20. The computer-readable storage medium of claim 14, the operations further comprising:
ranking the a plurality of entities at least in part by, for at least one of the plurality of entities,
identifying a plurality of performance metrics, and
for at least one of the identified plurality of performance metrics,
determining a rank of the entity for performance metric,
determining a number of the plurality of entities having a score for the performance metric,
determining a weight for the performance metric, and
calculating a score based on the determined rank, the determined number of entities, and the determined weight;
calculating an overall ranking for the entity based on a sum of the calculated scores, the total number of entities in the plurality of entities, and the total number of identified metrics.
